(19) United States
(12) Patent Application Publication
(10) Pub. No.: US 2025/0204731 A1
(43) Pub. Date: Jun. 26, 2025

(54) FAN MOTOR AND CLEANER INCLUDING THE SAME

(71) Applicant: Samsung Electronics Co., Ltd., Suwon-si (KR)

(72) Inventors: Masayuki TAKADA, Yokohama-shi (JP); Minoru YOSHIDA, Yokohama-shi (JP)

(73) Assignee: Samsung Electronics Co., Ltd., Suwon-si (KR)

(21) Appl. No.: 18/965,501

(22) Filed: Dec. 2, 2024

Related U.S. Application Data
(63) Continuation of application No. PCT/KR2024/019190, filed on Nov. 28, 2024.

(30) Foreign Application Priority Data
Dec. 26, 2023 (JP) 2023-220042

(51) Int. Cl. A47L 5/22; H02K 1/14; H02K 7/14

(52) U.S. Cl. CPC A47L 5/22; H02K 1/14; H02K 7/14

(57) ABSTRACT

A fan motor, and a cleaner including the fan motor, including a shaft having a rotational axis; a rotor fixed to the shaft, and including a plurality of magnetic poles about the rotor; and a stator including an annular core ring, a plurality of teeth protruding from the core ring toward the rotational axis, and a plurality of coils respectively wound around each tooth, wherein each tooth includes a protruding end facing the rotor with an air gap between the protruding end and an outer circumferential surface of the rotor, a first flange portion protruding from the protruding end in the rotation direction of the rotor, and a second flange portion protruding from the protruding end in an opposite direction of the rotation direction of the rotor, wherein the first and second flange portions are asymmetrical with respect to a central line of the tooth extending from the rotational axis.

### CROSS-REFERENCE TO RELATED APPLICATION

This application is a continuation application, under 35 U.S.C. § 111(a), of International Application No. PCT/KR2024/019190, filed on Nov. 28, 2024 which claims priority under 35 U. S. C. § 119 to Japanese Patent Application No. 2023-220042, filed on Dec. 26, 2023, the disclosures of which are incorporated herein by reference in their entireties.

### TECHNICAL FIELD

The disclosure relates to a fan motor and a cleaner including the same.

### BACKGROUND ART

Small and lightweight stick-type cleaners, robot cleaners, etc., that operate wirelessly to be easily handled have been developed. A small and lightweight cleaner is equipped with a suction fan (a mini fan) having a small impeller, the diameter of which is about 3 cm to 5 cm. To generate a high level of suction force by using a mini fan, a fan motor that rotates an impeller is also implemented as one that is small and lightweight and capable of rotating at a high speed of 50,000 revolutions per minute (rpm) or higher while generating appropriate torques.

For the small and lightweight cleaner, a high suction force which is equal to or higher than that of a previous canister-type cleaner is required, and thus, high-speed rotation of the fan motor has been progressed, and recently, a motor that rotates at an ultrahigh speed exceeding 100,000 rpm has also been realized. For the fan motor used in the small and lightweight cleaner, a small size, a light weight, a high output, and high efficiency and intensity are required.

Japanese Patent Laid-Open Publication No. 2021-100377 discloses a shape of a protruding end portion of teeth of a motor. Unlike a three-phase motor in which a rotation direction of a rotor is determined, the disclosed motor is a single-phase motor in which a rotation direction of a rotor is not determined because the number of magnetic poles of the rotor is the same as the number of teeth of a stator. Generally, in the single-phase motor, flange portions protruding at both horizontal sides of a protruding end of the teeth may have asymmetrical circumferential shapes, to allow air gaps at both sides of the teeth to have different sizes from each other, and thus, the rotation direction of the rotor may be determined. In the Japanese Patent Laid-Open Publication No. 2021-100377, the sizes of flange portions in a diameter direction vary along the rotation direction, to suppress the saturation of magnetic flux density and reduce iron loss. That is, the size of the flange portion in the diameter direction at a side in a rotation direction is greater than the size of the flange portion in the diameter direction at a side in a direction opposite to the rotation direction.

### DISCLOSURE

### Technical Solution

Aspects of embodiments of the disclosure will be set forth in part in the description which follows and, in part, will be apparent from the description, or may be learned by practice of the presented embodiments.

According to an embodiment of the disclosure, a cleaner includes a suction fan including a fan motor, and an impeller configured to be rotated by the fan motor to generate a suction force to suck in impurities on a surface to be cleaned; and a dust collection bin to accommodate sucked in impurities, wherein the fan motor includes a shaft that is rotatable about a rotational axis of the shaft, a rotor fixed to the shaft, and including a plurality of magnetic poles arranged in a rotation direction of the rotor, and a stator including a core ring having an annular shape, a plurality of teeth protruding from the core ring toward the rotational axis and arranged radially, and a plurality of coils arranged so that each coil of the plurality of coils is respectively wound around one tooth of the plurality of teeth, wherein each tooth of the plurality of teeth includes a protruding end facing the rotor with an air gap between the protruding end and an outer circumferential surface of the rotor, a first flange portion protruding from the protruding end in the rotation direction of the rotor, and a second flange portion protruding from the protruding end in an opposite direction of the rotation direction of the rotor, wherein the first flange portion and the second flange portion are asymmetrical with respect to a central line of the tooth extending from the rotational axis.

According to an embodiment of the disclosure, the second flange portion may include a second opposite surface which faces the air gap and extends from the central line in the opposite direction of the rotation direction of the rotor. A distance of the air gap between the second opposite surface and an outer circumferential surface of the rotor may increase in the opposite direction of the rotation direction of the rotor.

According to an embodiment of the disclosure, the first flange portion may include a first opposite surface which faces the air gap and extends from the central line in the rotation direction of the rotor. A distance of the air gap between the first opposite surface and the outer circumferential surface of the rotor may be constant.

According to an embodiment of the disclosure, the first opposite surface may have an arc shape that is concentric with the outer circumferential surface of the rotor. The second opposite surface may be a plane perpendicular to the central line.

According to an embodiment of the disclosure, a distance between the central line and an end of the second flange portion may be greater than a distance between the central line and an end of the first flange portion.

According to an embodiment of the disclosure, each tooth of the plurality of teeth may include a first side surface and a second side surface opposite to the first side surface, each of the first side surface and the second side surface being located a same distance from the central line. The first flange portion may protrude from the first side surface. The second flange portion may protrude from the second side surface.

According to an embodiment of the disclosure, a distance from the rotational axis to a first inflection point, the first inflection point being a boundary between the first flange portion and the first side surface, may be equal to a distance from the rotational axis to a second inflection point, the second inflection point being a boundary between the second flange portion and the second side surface.

According to an embodiment of the disclosure, the plurality of coils may form a three-phase coil group.

According to an embodiment of the disclosure, the rotor may include a permanent magnet including the plurality of magnetic poles and having a resistivity that is 10 Ω·cm or less.

According to an embodiment of the disclosure, the fan motor may include a metal cover covering an outer circumferential surface of the rotor.

According to an embodiment of the disclosure, a fan motor includes a shaft that is rotatable about a rotational axis of the shaft; a rotor fixed to the shaft, and including a plurality of magnetic poles arranged in a rotation direction of the rotor; and a stator including a core ring having an annular shape, a plurality of teeth protruding from the core ring toward the rotational axis and arranged radially, and a plurality of coils arranged so that each coil of the plurality of coils is respectively wound around one tooth of the plurality of teeth, wherein each tooth of the plurality of teeth includes a protruding end facing the rotor with an air gap between the protruding end and an outer circumferential surface of the rotor, a first flange portion protruding from the protruding end in the rotation direction of the rotor, and a second flange portion protruding from the protruding end in an opposite direction of the rotation direction of the rotor, wherein the first flange portion and the second flange portion are asymmetrical with respect to a central line of the tooth extending from the rotational axis.

According to an embodiment of the disclosure, the first flange portion may include a first opposite surface which faces the air gap and extends from the central line in the rotation direction of the rotor. The second flange portion may include a second opposite surface which faces the air gap and extends from the central line in the opposite direction of the rotation direction of the rotor. A distance of the air gap between the first opposite surface and an outer circumferential surface of the rotor may be constant. A distance of the air gap between the second opposite surface and the outer circumferential surface of the rotor may increase in the opposite direction of the rotation direction of the rotor.

According to an embodiment of the disclosure, a distance between the central line and an end of the second flange portion may be greater than a distance between the central line and an end of the first flange portion.

According to an embodiment of the disclosure, the rotor may include a permanent magnet including the plurality of magnetic poles and having a resistivity that is 10 Ω·cm or less.

According to an embodiment of the disclosure, the fan motor may further include a metal cover covering an outer circumferential surface of the rotor.

### DESCRIPTION OF DRAWINGS

The above and other aspects, features, and advantages of certain embodiments of the disclosure will be more apparent from the following description, taken in conjunction with the accompanying drawings listed below.

FIG. 1 is a schematic structural view of a cleaner according to an embodiment of the disclosure.

FIG. 2 is a schematic cross-sectional view of a suction fan according to an embodiment of the disclosure.

FIG. 3 is a schematic lateral cross-sectional view of a fan motor according to an embodiment of the disclosure.

FIG. 4 is an enlarged view of a protruding end portion of teeth according to an embodiment of the disclosure.

FIG. 5A shows a schematic cross-sectional view of a fan motor model used in a simulation, according to an embodiment of the disclosure.

FIG. 5B shows a schematic cross-sectional view of a fan motor model used in a simulation, according to a comparative example.

FIG. 6A shows a simulation result with respect to a relationship between protrusion amounts of a first flange portion and a second flange portion and the total iron loss.

FIG. 6B shows a simulation result with respect to a relationship between protrusion amounts of a first flange portion and a second flange portion and the eddy current loss.

FIG. 6C shows a simulation result with respect to a relationship between protrusion amounts of a first flange portion and a second flange portion and the stack thickness.

FIG. 7 is a schematic lateral cross-sectional view of a fan motor according to an embodiment of the disclosure.

### MODE FOR INVENTION

Various embodiments of the disclosure and terms used herein are not intended to limit the technical features described in this specification to particular embodiments of the disclosure, and it should be understood that various modifications, equivalents, or substitutes of the corresponding embodiments of the disclosure are also included in the technical features.

With regard to the description of the drawings, similar reference numerals may be used for similar or relevant components.

A singular form of a noun corresponding to an item may include a singular number or a plural number of the item, unless apparently otherwise indicated in the context.

In this disclosure, each of expressions such as “A or B,” “at least one of A and B,” “at least one of A or B,” “A, B, or C,” “at least one of A, B, and C,” and “at least one of A, B, or C” may include any one of items listed together with the corresponding expression or all possible combinations of the same.

The expression “and/or” includes a combination of a plurality of described relevant components or any one of the plurality of described relevant components.

Terms such as “1st,” “2nd,” “first,” and “second” may be merely used to distinguish a corresponding component from other corresponding components and do not limit the corresponding components in terms of other aspects (for example, the degree of importance or the order).

When a certain (for example, a first) element is referred to as being “coupled” or “connected” to another (for example, a second) element with the term “functionally” or “communicatively” or without this term, it denotes that the element may be connected to the other element directly (for example, in a wired manner), wirelessly, or through a third element.

The term “including” or “having” is used to indicate a presence of a feature, a number, a step, an operation, an element, a component, or a combination thereof described herein, and the term does not exclude a presence of one or more other features, numbers, steps, operations, elements, components, or a combination thereof or the possibility of an addition of the same.

When a certain element is referred to as being “connected to,” “coupled to,” “supported by,” or “in contact with” another element, it denotes not only the case where the elements are directly connected to, coupled to, supported by, or in contact with each other, but also the case where the elements are indirectly connected to, coupled to, supported by, or in contact with each other through a third element.

When a certain element is referred to as being “above” another element, it includes not only the case where the element is in contact with the other element, but also the case where yet another element is present between the two components.

In order to realize a highly efficient and highly intense suction fan, rare earth sintered magnets having great magnetic power and high intensity, such as a neodymium magnet, etc., may be used in a rotor of a motor. However, these magnets may have small resistivity, and thus, may be heated due to eddy currents. When the rotor rotates at an ultrahigh speed, the magnet may immediately have a high temperature. Thus, it is difficult to apply the rare earth sintered magnet to the rotor. To consider this aspect, it is general that a bond magnet, which has low magnetic power but high resistivity, is used in the motor of the suction fun.

The disclosure provides a suction fan having a structure configured to reduce heat generation of a rotor due to an eddy current and a cleaner using the suction fan. The disclosure provides a suction fan having a structure configured to improve the performance of a motor and a cleaner using the suction fan. However, the technical objectives to be achieved by the disclosure are not limited to the technical tasks described above, and other technical tasks that are not described above may be clearly understood by one of ordinary skill in the art from the description below.

Hereinafter, the suction fan and the cleaner implementing the suction fan according to an embodiment of the disclosure will be described in detail, for one of ordinary skill in the art to easily implement the suction fan and the cleaner implementing the suction fan according to an embodiment of the disclosure. However, the disclosure may have different forms and should not be construed as being limited to the embodiment of the disclosure described herein. Also, in the drawings, parts not related to descriptions are omitted for the clear description of the disclosure, and throughout the specification, like reference numerals are used for like elements.

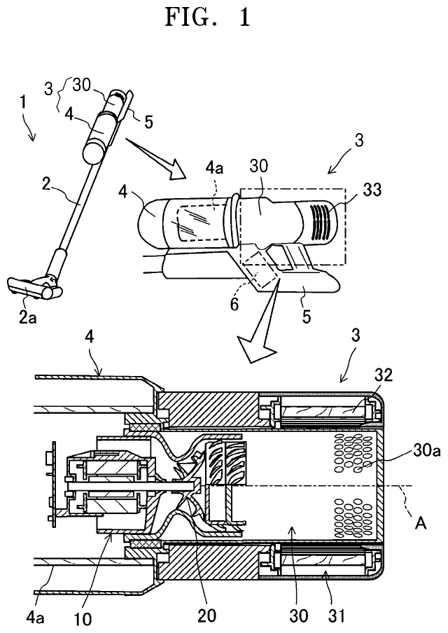

FIG. 1 is a schematic structural view of a cleaner according to an embodiment of the disclosure. The cleaner illustrated in FIG. 1 is a stick-type cleaner, and hereinafter, is simply referred to as a cleaner 1. The cleaner 1 may be a wireless type. However, the cleaner 1 is not limited thereto. The disclosure may be applied to a handy cleaner or a robot cleaner. Referring to FIG. 1, the cleaner 1 according to an embodiment of the disclosure may include a rechargeable battery 6 and may be a wireless vacuum cleaner, for which it is not required to connect a power cord to an outlet during cleaning. The cleaner 1 according to an embodiment of the disclosure may include a main body 3, a brush device 2a, and an extension pipe 2. However, not all components illustrated in FIG. 1 are essential components. The cleaner 1 may be realized by including more or less components than the components illustrated in FIG. 1. For example, the cleaner 1 may be realized by excluding the extension pipe 2 and including the main body 3 and the brush device 2a. Also, the cleaner 1 may further include a station (not shown) for discharging dust from the main body 3 and charging the battery 6.

The main body 3 may include a suction fan 10 forming a vacuum in the cleaner 1, a dust collection bin (a dust bin) 4, in which impurities sucked in from a surface to be cleaned (e.g., a floor, bedclothes, a sofa, etc.) are accommodated, etc. Also, the main body 3 may include a handle 5 which may be held by a user to move the cleaner 1 during cleaning.

The main body 3 may include a mount portion in which the extension pipe 2 or the brush device 2a is mounted. The extension pipe 2 may include a hollow pipe. The extension pipe 2 may have certain rigidity. Also, the extension pipe 2 may include a flexible hose. The brush device 2a may be detachably connected to an end of the extension pipe 2. The other end of the extension pipe 2 may be detachably connected to an extension pipe mount portion of the main body 3. Through the extension pipe 2, a suction force generated by the suction fan 10 of the main body 3 may be transmitted to the brush device 2a, and air and impurities sucked in through the brush device 2a may be transported to the main body 3. The extension pipe 2 may be in a form of a multiple stage between the main body 3 and the brush device 2a. The extension pipe 2 may include two or more extension pipes.

The brush device 2a is a device that can come in close contact to a surface to be cleaned and suck in air and impurities from the surface to be cleaned. The brush device 2a may be referred to as a cleaning head. The brush device 2a may be coupled to the extension pipe 2 to be rotatable. Types of the brush device 2a may vary. For example, the brush device 2a may include, according to the purpose of use, a general brush (a floor brush), a carpet brush, a bedclothes brush, a pet brush, a wet mop brush, a multi-purpose brush (a brush usable for both a carpet and a floor), etc., but is not limited thereto.

According to an embodiment of the disclosure, each of the main body 3, the brush device 2a, and the extension pipe 2 may include a power line (for example, a +power line and a −power line) and a signal line. The power line may be configured to transmit power supplied from the battery 6 to the main body 3 and, according to necessity, to the brush device 2a connected to the main body 3. The signal line may be different from the power line and may be configured to transmit and receive signals to and from the main body 3 and the brush device 2a. The signal line may be configured to be connected to the power line in the brush device 2a.

The main body 3 may include a suction force generator (hereinafter, referred to as the suction fan 10) configured to generate a suction force required to suck in impurities on a surface to be cleaned, the dust collection bin 4 (also referred to as the dust bin) accommodating the impurities sucked in from the surface to be cleaned, an exhaust portion 30, a filter portion 31, and the battery 6 configured to supply power to the suction fan 10. Although not shown in the drawings, the main body 3 may further include a communication interface, a user interface, a main processor, and a memory.

The suction fan 10 may include a fan motor configured to convert electric power to mechanical rotational power, an impeller connected to the fan motor and rotated, and a printed circuit board connected to the fan motor. A vacuum may be formed in the cleaner 1 by the fan motor rotating the impeller. Here, the vacuum denotes a state having an air pressure lower than the atmospheric pressure. The fan motor may include a brushless motor, but is not limited thereto. The printed circuit board may include various electrical and electronic components configured to control the fan motor. The suction fan 10 may have a reverse motor structure in which the positions of the impeller and the printed circuit board are reversed. In the reverse motor structure, the printed circuit board may be positioned at the upstream side of the fan motor and the impeller may be positioned at the downstream side of the fan motor with respect to an air flow direction. Thus, the impeller may be closer to the filter portion 31 than the printed circuit board. The suction fan 10 may be positioned across the dust collection bin (the dust bin) 4 and the exhaust portion 30. The suction fan 10 will be described in detail below.

The dust collection bin 4 may be configured to filter out and collect dust or impurities of the air introduced through the brush device 2a. The dust collection bin 4 may be provided to be detachable from the main body 3. The dust collection bin 4 may collect the impurities through a cyclone method that separates impurities using a centrifugal force. The air from which the impurities are removed through the cyclone method may be discharged to the outside of the main body 3 and the impurities may be stored in the dust collection bin 4. Multi-cyclones may be arranged in the dust collection bin 4. The dust collection bin 4 may be provided to collect the impurities below the multi-cyclones. The dust collection bin 4 may include a dust collection bin door (also referred to as a cover of the dust collection bin 4) configured to open the dust collection bin 4 when the dust collection bin 4 is connected to a station not shown. The dust collection bin 4 may include a first dust collector configured to collect relatively large impurities which are primarily collected and a second dust collector configured to collect relatively small impurities collected by the multi-cyclones. Both the first dust collector and the second dust collector may be provided to be open to the outside when the dust collection bin door is open.

Air that has passed through the dust collection bin 4 may flow into the exhaust portion 30. The exhaust portion 30 may have, for example, a hollow cylindrical shape and may include, at the outer circumference thereof, inner exhaust holes 30a to discharge air. For example, the filter portion 31 may be arranged to surround the exhaust portion 30. The filter portion 31 may include a filter 32. The filter 32 may have, for example, a cylindrical shape. The filter 32 may be arranged to surround the outer circumference of exhaust portion 30. A plurality of outer exhaust holes 33 may be formed at a case of the main body 3 forming an outer edge of the filter portion 31. The filter portion 31 may include the filter 32 configured to filter out ultrafine dust, etc., not filtered out by the dust collection bin 4. The filter 32 may include a motor filter, a HEPA filter, etc., but is not limited thereto. Air may be introduced into the filter portion 31 from the exhaust portion 30 through the inner exhaust holes 30a, and after passing through the filter 32, may be discharged to the outside of the cleaner 1 through the outer exhaust holes 33.

The battery 6 may be detachably mounted on the main body 3. The battery 6 may be referred to as a battery pack or a battery module. The battery 6 may be electrically connected to a charge terminal provided in a station. The battery 6 may be charged by receiving a power supply from the charge terminal. According to an embodiment of the disclosure, the battery 6 may include a processor (e.g., MICOM (a micro-computer, microprocessor computer, microprocessor controller)) configured to control a voltage supplied to the main body 3 and communicate with a main processor. The battery 6 may perform data communication with the main processor. The battery 6 may periodically transmit information, such as a charge state, an output voltage, etc., of the battery, to the main processor.

The battery 6 may include a light-emitting diode (LED) display to indicate a charge/discharge status, a state, or the like of the battery 6. For example, the processor of the battery 6 may output a red color, an orange color, or a yellow color through the LED display according to a charge rate, and when charging is completed, may output a green color through the LED display.

The communication interface may include a module configured to perform communication with an external device. For example, the main body 3 may perform communication with the station or a server device through the communication interface. The communication interface may include a short-range wireless communication interface, a long-range communication interface, etc. The short-range wireless communication interface may include a Bluetooth communicator, a Bluetooth low energy (BLE) communicator, a near-field communication (NFC) interface, a wireless local area network (WLAN) (or WiFi) communicator, a Zigbee communicator, an infrared data association (IrDA) communicator, a WiFi direct (WFD) communicator, an ultra wideband (UWB) communicator, an Ant+ communicator, etc., but is not limited thereto. The long-range communication interface may be used for the main body to communicate with the server device. The long-range communication interface may include the Internet, a computer network (for example, a local area network (LAN) or a wide area network (WAN)), or a mobile communicator. The mobile communicator may include a 3rd generation (3G) module, a 4th generation (4G) module, a 5th generation (5G) module, a long term evolution (LTE) module, an NB-IoT module, an LTE-M module, etc., but is not limited thereto.

The user interface may be provided at the handle 5 or the main body 3. The user interface may include an input interface and an output interface. The main body 3 may receive a user input related to an operation of the cleaner 1 and output information related to an operation of the cleaner 1, through the user interface. The main body 3 may output, through the user interface, information about an operation state (e.g., an operation mode), information about a residual charge of the battery, information about a mounting (docking) state, information about a state of the dust bin 4, information about a state of a dust bag, information about moisture introduction, information about impurities stuck in the brush device 2a, etc.

The input interface may include at least one of a motion input portion, a voice input portion (e.g., a microphone), or a manipulation input portion (e.g., a power button or a button for adjusting a suction force intensity), but is not limited thereto. The output interface may include an LED display, a liquid crystal display (LCD), a touch screen, a speaker, etc., but is not limited thereto.

The main body 3 may include at least one processor. The main body 3 may include one processor or a plurality of processors. For example, the main body 3 may include a main processor connected to the user interface and a processor connected to the fan motor. The at least one processor may control the overall operations of the cleaner. For example, the at least one processor may control power consumption (a suction force intensity or a suction force mode) of the fan motor, the rotation speed of a drum of the brush device 2a, a trip level of the brush device 2a, etc.

The at least one processor according to the disclosure may include at least one of a central processing unit (CPU), a graphics processing unit (GPU), an accelerated processing unit (APU), many integrated cores (MIC), a digital signal processor (DSP), or a neural processing unit (NPU). The at least one processor may be realized as an integrated system on chip (SoC) including one or more electronic components. Each of the at least one processor may be realized as separate hardware (H/W). The at least one processor may be represented as a micro-computer, microprocessor computer, or microprocessor controller (MICOM), a microprocessor unit (MPU), or a microcontroller unit (MCU).

The at least one processor according to the disclosure may be realized as a single-core processor or a multi-core processor.

The memory may store programs for processing and controlling by the at least one processor and may store input/output data. For example, the memory may store a pre-trained artificial intelligence (AI) model (e.g., a support vector machine (SVM) algorithm, etc.), state data of the fan motor, a measurement value of a pressure sensor measuring flow path pressure, state data of the battery 6, state data of the brush device 2a (e.g., the rotation speed of a drum), error occurrence data (breakdown history data), power consumption of the fan motor according to an operation condition, an operation sequence of the fan motor according to a suction force generation pattern, a type of the brush device 2a according to a voltage value input through the signal line, a trip level according to each type of the brush device 2a, a pulse-width modulation (PWM) frequency according to each type of the brush device 2a, an average input voltage according to each type of the brush device 2a, a high load reference value (or a low load reference value) according to each type of the brush device 2a, information about motion patterns (user gestures) pre-defined according to a plurality of control commands, information about moisture introduction into the main body 3, reference load values (e.g., a plurality of reference load values corresponding to a plurality of suction force modes) for classifying states of a surface to be cleaned (e.g., a floor or a carpet), etc.

The memory may include an external memory and an embedded memory. For example, the memory may include at least one type of storage medium from among a flash memory type, a hard disk type, a multimedia card micro type, a card-type memory (for example, a secure digital (SD) memory or an extreme digital (XD) memory), random-access memory (RAM), static RAM (SRAM), read-only memory (ROM), electrically erasable programmable ROM (EEPROM), programmable ROM (PROM), a magnetic memory, a magnetic disk, and an optical disk. The programs stored in the memory may be classified into a plurality of modules according to their functions.

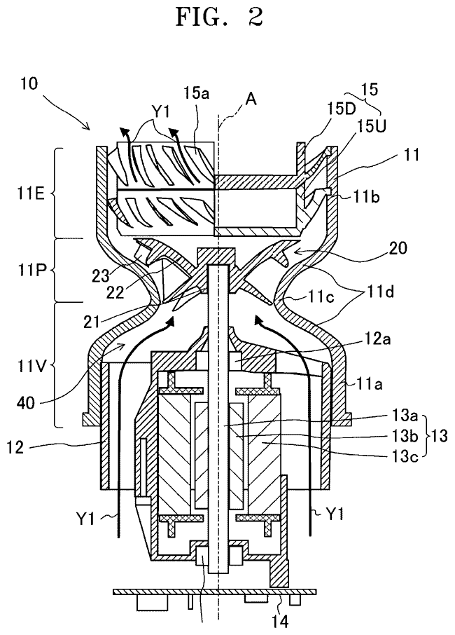

FIG. 2 is a schematic cross-sectional view of the suction fan 10 according to an embodiment of the disclosure. Referring to FIG. 2, the suction fan (the mini fan) 10 may include a fan motor 13 and an impeller 20 rotated by the fan motor 13. The impeller 20 may be arranged in the main body 3 and may be rotated to generate a suction force necessary to suck in impurities on a surface to be cleaned. The suction fan 10 may further include a shroud 11 in which a flow path (a wind passage) 40 through which air flows is formed. For example, the impeller 20 may generate a suction force so that air is sucked in to the main body 3 from the dust collection bin 4 through the wind passage 40. The suction fan 10 may further include a diffuser 15. In FIG. 2, with respect to a rotational axis A, the left side illustrates an outer shape of the diffuser 15 and the right side illustrates a cross-sectional shape of the diffuser 15. The impurities sucked in from the surface to be cleaned may be accommodated in the dust collection bin 4.

The shroud 11 may cover an external portion of the wind passage 40. During the rotation of the impeller 20, the air in the wind passage 40 may flow as indicated by an arrow Y1 in FIG. 2. Hereinafter, an “upstream” side and a “downstream” side are defined with respect to the air flow direction Y1. The shroud 11 may include a cylindrical member having a concave central portion. The shroud 11 may include an upstream large diameter portion 11a having a large inner diameter, a small diameter portion 11c having a smallest inner diameter, and a downstream large diameter portion 11b having a large inner diameter. The small diameter portion 11c may be located between the upstream large diameter portion 11a and the downstream large diameter portion 11b. An intermediate area 11d may be provided at each of a downstream portion of the upstream large diameter portion 11a and an upstream portion of the downstream large diameter portion 11b. An inner diameter of each intermediate area 11d may gradually decrease toward the small diameter portion 11c from the upstream large diameter portion 11a or the downstream large diameter portion 11b.

Referring to FIG. 1, the suction fan 10 may be accommodated in the main body 3 such that a portion of the suction fan 10 may be partially inserted into the exhaust portion 30. The downstream large diameter portion 11b may be arranged in the exhaust portion 30. The upstream large diameter portion 11a may be arranged to be partially inserted into the dust collection bin 4, while being covered around by a filter case 4a configured to remove dust from air.

From the functional perspective of the wind passage 40, the shroud 11 may include a moving blade portion 11P, a suction portion 11V extending from the moving blade portion 11P to the upstream side, and a static blade portion 11E extending from the moving blade portion 11P to the downstream side. The moving blade portion 11P may include a portion from the small diameter portion 11c to the intermediate area 11d of the downstream large diameter portion 11b. Thus, the moving blade portion 11P may have a shape in which an inner diameter of the moving blade portion 11P gradually increases toward the downstream side from the upstream side. The impeller 20 may be accommodated in the moving blade portion 11P.

The suction portion 11V may include the upstream large diameter portion 11a and the intermediate area 11d connecting the upstream large diameter portion 11a with the small diameter portion 11c. Thus, an inner diameter of the suction portion 11V may gradually decrease from an upstream side of the wind passage 40 to a downstream side of the wind passage 40, and in the suction portion 11V, air may flow from the outside with respect to a diameter direction toward the inside with respect to the diameter direction, along an inner surface of the suction portion 11V. The fan motor 13 may be accommodated in the suction portion 11V. The static blade portion 11E may include the downstream large diameter portion 11b. The diffuser 15 may be accommodated in the static blade portion 11E.

The fan motor 13 may include a shaft 13a, a rotor 13b, and a stator 13c. A motor case 12 may be accommodated in the upstream large diameter portion 11a. The shaft 13a may be supported at the center of the motor case 12 to be rotatable with respect to the rotational axis A with a bearing 12a between the shaft 13 and the motor case 12. The rotor 13b may be fixed at a central portion of the shaft 13a. The stator 13c may be assembled at the motor case 12 to be located around the rotor 13b with an air gap Ga between the stator 13c and the rotor 13b. Thus, the fan motor 13 including the shaft 13a, the rotor 13b, and the stator 13c may be arranged at a central portion of the suction portion 11V. The fan motor 13 may be integrally provided with the motor case 12. The rotational axis A of the fan motor 13 may correspond to the centers of the motor case 12 and the shroud 11. The fan motor 13 will be described in detail below.

An end of the shaft 13a may protrude from the motor case 12. The motor case 12 may be inserted into and accommodated in the shroud 11 so that the protruding end of the shaft 13a is toward the downstream side. Thus, the wind passage 40 may be formed between the fan motor 13 and an inner surface of the suction portion 11V of the shroud 11, that is, an inner surface of the upstream large diameter portion 11a.

A controller 14 for controlling the fan motor 13 may be mounted at the upstream side of the motor case 12. The controller 14 may include a printed circuit board on which an electronic component, such as a motor driving integrated circuit (IC), etc., is mounted. For example, in the wind passage 40, the fan motor 13 may located at the upstream side of the impeller 20, and the controller 14 may be arranged at the upstream side of the fan motor 13. The controller 14 may be arranged such that the printed circuit board of the controller 14 crosses the wind passage 40. The controller 14 may control a driving operation of the fan motor 13 according to a manipulation signal input through the user interface of the cleaner 1.

The fan motor 13 may be small-sized. The stator 13c may have a so-called palm-size with an outer diameter of 50 mm or less and the total height of 80 mm or less. For example, according the present embodiment of the disclosure, the outer diameter of the stator 13c may be about 40 mm, and the height of the stator 13c may be about 70 mm. Thus, the fan motor 13 may also be very lightweight. The fan motor 13 as described above may be referred to as a mini fan motor.

The fan motor 13 may be configured to be highly efficient to produce a high output, thereby securing sufficient performance to be used by the cleaner 1 by using the power of the battery 6. For example, the power of 500 W or higher may be input to the fan motor 13 according to an embodiment of the disclosure, and thus, the fan motor 13 may be configured to produce an output with ultrahigh-speed rotation of 100,000 rpm or greater.

The diffuser 15 may be accommodated in the static blade portion 11E. The diffuser 15 according to the present embodiment of the disclosure may include an upper diffuser 15U and a lower diffuser 15D. According to the specifications of the suction fan 10, the diffuser 15 may include one diffuser or may include three or more diffusers.

Each of the upper diffuser 15U and the lower diffuser 15D may include a cylindrical member and a plurality of vanes 15a obliquely extending with respect to an axial direction (for example, a direction of the rotational axis A) may be formed at an outer circumferential surface of each of the upper diffuser 15U and the lower diffuser 15D. An inclination angle of the vanes 15a of the lower diffuser 15D may be less an inclination angle of the vanes 15a of the upper diffuser 15U. Each of the upper diffuser 15U and the lower diffuser 15D may be fixed at an inner circumferential surface of the downstream large diameter portion 11b.

As described above, the impeller 20 may be arranged at the moving blade portion 11P of the shroud 11 forming the wind passage 40. The impeller 20 may include a boss portion 21 fixed to the shaft 13a of the fan motor 13 while the rotational axis A of the impeller 20 is aligned with the shaft 13a of the fan motor 13, a base portion 22 which is annular and extends to a peripheral portion from the boss portion 21, and a plurality of blades 23. The plurality of blades 23 may be arranged radially on the base portion 22 and may generate a suction force in the wind passage 40.

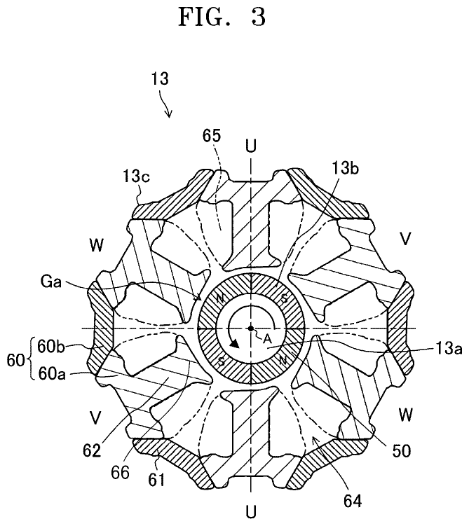

During the driving of the cleaner 1, the shaft 13a of the fan motor 13 may rotate at a high speed in a certain direction, for example, according to the present embodiment of the disclosure, in an anti-clockwise direction (see FIG. 3) viewed from the upstream side. Thus, because the impeller 20 is rotated at an ultrahigh speed, air may flow from the dust collection bin 4 into the shroud 11 through the motor case 12 as indicated by the arrow Y1 in FIG. 2, to generate a suction force at an upstream side of the moving blade portion 11P, that is, the suction portion 11V, etc.

The air flowing toward the shroud 11 may be sucked into the moving blade portion 11P while cooling the controller 14 and the fan motor 13 through an air cooling method. Heat generation of the controller 14 and the fan motor 13 may be increased concomitantly with the high speed or the high suction force, and thus, it is important to cool the controller 14 and the fan motor 13. In the suction fan 10 according to an embodiment of the disclosure, the controller 14 and the fan motor 13 may be arranged at the upstream side of the moving blade portion 11P, and thus, the controller 14 and the fan motor 13 may exchange heat with air having a relatively low temperature like the outdoor air. Thus, the cooling performance of the controller 14 and the fan motor 13 may be excellent.

Air may flow through the moving blade portion 11P in a focused way by being bent from the outer circumferential side to the central side in the suction portion 11V. In detail, after the air flows in an axial direction along the inner surface of the upstream large diameter portion 11a and an external portion of the fan motor 13, the air may flow from the outer circumferential side (outside a diameter direction) toward the central side (inside the diameter direction) toward the moving blade portion 11P through the inner surface of the intermediate area 11d of the upstream large diameter portion 11a and an end of the fan motor 13. Thus, the air may flow efficiently in contact with the controller 14 and the fan motor 13 to easily exchange heat with the controller 14 and the fan motor 13. Thus, the cooling performance of the controller 14 and the fan motor 13 may be further improved.

The air introduced into the moving blade portion 11P may be introduced into the static blade portion 11E by passing through a space between the inner surface of the moving blade portion 11P and the base portion 22 of the impeller 20 (in detail, between the plurality of blades 23). The air introduced into the static blade portion 11E may be introduced into the exhaust portion 30 by passing through a space between the inner surface of the static blade portion 1E and the outer circumferential surface of the diffuser 15 (in detail, between the plurality of vanes 15a).

By passing through the diffuser 15, the air, which is rectified, may be introduced into the exhaust portion 30 in the axial direction. The air introduced into the exhaust portion 30 may be emitted to the filter portion 31 through the inner exhaust holes 30a and may be discharged to the outside of the main body 3 through the outer exhaust holes 33.

FIG. 3 is a schematic lateral cross-sectional view of the fan motor 13 according to an embodiment of the disclosure. Referring to FIG. 3, the fan motor 13 may include the shaft 13a, the rotor 13b, and the stator 13c. The shaft 13a may rotate with respect to the rotational axis A.

The rotor 13b may include a plurality of magnetic poles arranged in a rotation direction. The rotor 13b may be formed, for example, as a permanent magnet 50 which is cylindrical. The plurality of magnetic poles may include an N-pole and an S-pole that are alternately arranged. According to the present embodiment of the disclosure, the rotor 13b may include four (4) magnetic poles. The 4 magnetic poles may be arranged in a circumferential direction of the rotor 13b at equal intervals. 2 N-poles and 2 S-poles may be arranged in the circumferential direction of the rotor 13b at equal intervals. The structure of the rotor 13b is not limited thereto. Although not shown, the rotor 13b may be formed by attaching the permanent magnet 50 onto a surface of a rotor core formed by stacking steel plates in an axial direction.

The stator 13c may include a core ring 61, a plurality of teeth 62, and a plurality of coils 65. For example, the stator 13c may include a stator core 60 formed by stacking steel plates in an axial direction. The stator core 60 according to the present embodiment of the disclosure may be formed by alternately connecting, in a circumferential direction, two types of components (a first component 60a and a second component 60b) each including 6 components. Thus, the stator core 60 may include the core ring 61 which is annular and the plurality of teeth 62 protruding from the core ring 61 toward the inside, for example, toward the rotational axis A, and arranged radially. The stator core 60 according to the present embodiment of the disclosure may include the six (6) teeth 62. The six teeth 62 may protrude from the annular core ring 61 toward the inside and may be arranged in the circumferential direction at equal intervals. The teeth 62 may be spaced apart from the rotor 13b with the air gap Ga therebetween. An inner surface of the stator core 60, except for a surface of the stator core 60 facing the air gap Ga, may be coated with an insulator not shown.

By wrapping a wire around each of the plurality of teeth 62 through a slot 64 between two adjacent teeth 62, the coil 65 may be coupled to each of the plurality of teeth 62. The plurality of coils 65 may form a three-phase coil group including a U-phase, a V-phase, and a W-phase. In detail, in the case of the fan motor 13 according to the present embodiment of the disclosure, there may be six teeth 62, and thus, two coils 65 facing each other may be electrically connected to each other and may form a coil group corresponding to one phase.

A pole/slot combination of the fan motor 13 according to the present embodiment of the disclosure may be 4 poles/6 slots. However, the pole/slot combination of the fan motor 13 is not limited thereto and may include 2 poles/3 slots or 6 poles/9 slots. In other words, the fan motor 13 according to the present embodiment of the disclosure may be very small, and thus, the pole/slot combination may be desirably 2n poles/3n slots (n=1, 2, or 3).

The fan motor 13 may include a so-called three-phase motor. Thus, by periodically supplying currents having different phases to the coil groups having different phases, for example, a U-phase coil group, a V-phase coil group, and a W-phase coil group, the rotor 13b may be driven to rotate in a certain direction. For example, as described above, the rotor 13b may rotate in an anti-clockwise direction, when viewed from the upstream side to the downstream side with respect to the air flow direction as described above.

In the fan motor 13 according to an embodiment of the disclosure, a rare earth sintered magnet having a strong magnetic force may be used as the permanent magnet 50 of the rotor 13b. Rare earth sintered magnets which may be applied to the rotor 13b may include a neodymium magnet, samakova magnet, an Al—Ni—Co magnet, etc. For example, a neodymium magnet may be used as the permanent magnet 50. There may be a bond magnet or a rubber magnet which is formed by mixing powder of the rare earth sintered magnet with a synthetic resin or rubber. However, the rare earth sintered magnet has high purity and a stronger magnetic force than the bond magnet, etc., and thus, may be preferable for the magnetic poles of the rotor 13b.

While it is hard for electricity to flow through the bond magnet, etc., it is very easy for electricity to flow through the rare earth sintered magnet. In detail, while the resistivity of the bond magnet, etc., is generally 10,000 Ω·cm or higher, the resistivity of the rare earth sintered magnet is 10 Ω·cm or lower. Thus, when a rare earth sintered magnet is used for magnetic poles, eddy currents may be generated and it may be easy to emit heat. Thus, when the rotor 13b in which the rare earth sintered magnet is used rotates at an ultrahigh speed, the rotor 13b may immediately have a high temperature, and thus, it may be very difficult to manage the temperature. For this reason, a bond magnet having a small magnetic force may be generally used for the rotor 13b.

However, to further improve the efficiency and intensity of the fan motor 13, it is inevitable that the permanent magnet 50 having a large magnetic force is used for forming the magnetic poles of the rotor 13b. Therefore, the teeth 62 of the fan motor 13 according to the present embodiment of the disclosure may have a protruding end shape, whereby the occurrence of eddy currents may be effectively suppressed to reduce heat generation, even when the permanent magnet 50 having a very small resistivity, thereby causing electricity to easily flow therethrough, is used.

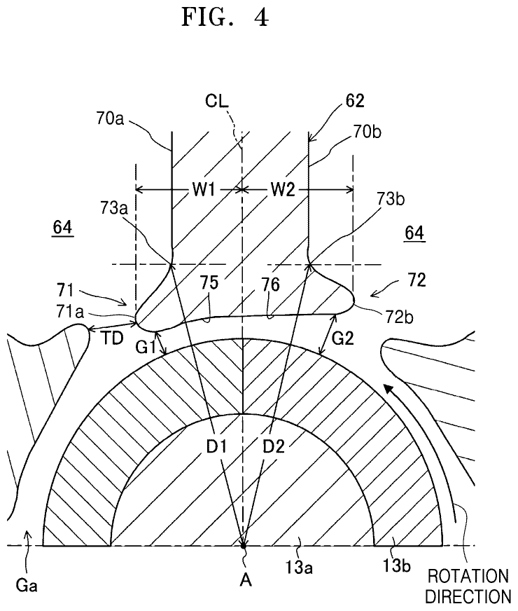

Referring to FIG. 3, each of the plurality of teeth 62 may have a post shape extending from the core ring 61 toward the inside in a diameter direction. Each of the plurality of teeth 62 may include a protruding end 66 close to the rotor 13b. The protruding end 66 may face the rotor 13b with the air gap Ga therebetween. FIG. 4 is an enlarged view of the protruding end 66 of the teeth 62 according to an embodiment of the disclosure. Referring to FIG. 4, a central line CL of each of the teeth 62 may cross the rotational axis A, when viewed in an axial direction. The teeth 62 may include a pair of side surfaces 70a and 70b located at the same distances from the central line CL and approximately parallel to each other. The pair of the side surfaces 70a and 70b may face the slots 64 located at both sides of the teeth 62.

At the protruding end 66 of the teeth 62, that is, at a portion adjacent to the rotor 13b, a pair of flange portions 71 and 72 may respectively protrude from the pair of the side surfaces 70a 70b, respectively. In the case of a three-phase motor, generally, the pair of the flange portions 71 and 72 may be symmetrical, for the purpose of ripple suppression, etc. However, the fan motor 13 according to an embodiment of the disclosure may rotate in a certain direction, and thus, by implementing the pair of the flange portions 71 and 72 having an asymmetrical shape, leakage flux may be reduced to improve the performance as well as effectively suppress the generation of eddy currents.

In detail, a flange portion (the first flange portion 71) protruding in a rotation direction (an anti-clockwise direction in the fan motor 13 according to the present embodiment of the disclosure) and a flange portion (the second flange portion 72) protruding in an opposite direction of the rotation direction (a clockwise direction in the fan motor 13 of the present embodiment of the disclosure) may be provided at the protruding end 66 of each of the teeth 62.

Protrusion amounts of the first and second flange portions 71 and 72 respectively from the pair of the side surfaces 70a and 70b may increase toward the rotational axis A. In other words, each of the first and second flange portions 71 and 72 may be formed to protrude more in a circumferential direction, toward the inside in a diameter direction from each of the pair of the side surfaces 70a and 70b of the teeth 62. Thus, there may be inflection points, that is a first inflection point 73a and a second inflection point 73b, at which surface shapes are greatly changed, at boundary portions between the first and second flange portions 71 and 72 and the both side surfaces 70a and 70b of the teeth 62. A distance D1 from the rotational axis A to the first inflection point 73a of the first flange portion 71 may be the same as a distance D2 from the rotational axis A to the second inflection point 73b of the flange portion 72. That is, lengths of the both side surfaces 70a and 70b of the teeth 62 in the diameter direction may be the same. Thus, even when the shapes of the first and second flange portions 71 and 72 are asymmetrical, bad effects caused by the flange portions, such as deterioration of a space factor of the coil 65 winded around the teeth 62, collapse of the winding, etc., may be prevented.

The first flange portion 71 may include an opposite surface 75 facing the air gap Ga. The opposite surface 75 may be a surface of the protruding end 66 of the teeth 62 extending from the central line CL in the rotation direction. The opposite surface 75 may be referred to as the first opposite surface 75. The first opposite surface 75 may have an arc shape concentric with an outer circumferential surface of the rotor 13b. Thus, a distance between the first opposite surface 75 of the first flange portion 71 and the outer circumferential surface of the rotor 13b (a first gap G1) may be approximately constant throughout the first opposite surface 75.

The second flange portion 72 may include an opposite surface 76 facing the air gap Ga. The opposite surface 76 may be a surface of the protruding end 66 of the teeth 62 extending from the central line CL in the opposite direction of the rotation direction. The opposite surface 76 may be referred to as the second opposite surface 76. The second opposite surface 76 may be a plane perpendicular to the central line CL of the teeth 62. Thus, a distance between the second opposite surface 76 of the second flange portion 72 and the outer circumferential surface of the rotor 13b (a second gap G2) may increase in the opposite direction of the rotation direction.

By doing so, a distance TD between the first flange portion 71 of any one of the teeth 62 and the second flange portion 72 of another of the teeth 62 adjacent thereto may be greater than that of a case where the teeth 62 have a pair of flange portions that are symmetrical. As a result, leakage flux may be reduced, and thus, the performance of the fan motor 13 may be improved.

Also, the gap G2 may gradually increase away from the central line CL of the teeth 62, and thus, the flux may gradually decrease at the opposite directional side of each of the teeth 62. Thus, the eddy currents generated in the permanent magnet 50 of the rotor 13b may be reduced, and thus, the heat generation of the permanent magnet 50 may be effectively suppressed. As a result, the rare earth sintered magnet having little resistivity may be applied to the rotor 13b, and thus, the magnetic force of the magnetic poles of the rotor 13b may be strengthened.

However, as the second gap G2 increases, the torque of the fan motor 13 may decrease. On the contrary, the first gap G1 at the rotation side may be approximately constant, and thus, deterioration of the torque may be suppressed at the opposite directional side of each of the teeth 62. Thus, while suppressing the deterioration of the torque, the eddy currents may be reduced, and thus, the performance of the fan motor 13 may be improved in a balanced way.

Also, a distance between the central line CL of the teeth 62 and a protruding end portion 71a of the first opposite surface 75 (a protrusion amount W1 of the first flange portion 71) may be greater than a distance between the central line CL of the teeth 62 and a protruding end portion 72b of the second opposite surface 76 (a protrusion amount W2 of the second flange portion 72).

The present inventors have examined the effects of the protrusion amounts of the first and second flange portions 71 and 72 on the major characteristics through simulations. In detail, the protrusion amount W1 of the first flange portion 71 and the protrusion amount W2 of the second flange portion 72 were changed between about 1.8 mm and about 2.6 mm by using a motor model, and the effects of the change on the loss (total iron loss) of the cores of the rotor 13b and the stator 13c, the loss (eddy current loss) of eddy currents of the rotor 13b, and the stack thickness of the stator core 60 were examined.

Desirably, the total iron loss and the eddy current loss may be small for the sake of improvement of efficiency. Desirably, the stack thickness may be small for the sake of a light weight. When the stack thickness increases, the size of the coil 65 may be increased and the thickness of the rotor 13b may be increased accordingly, to have a large effect on the weight.

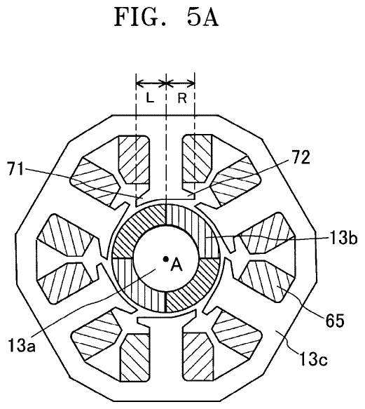

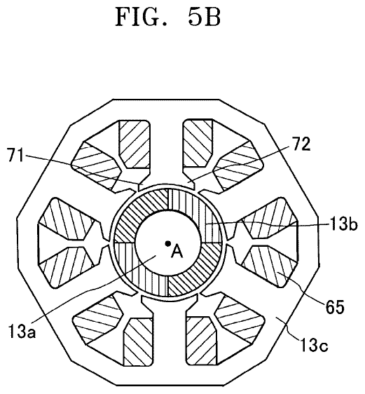

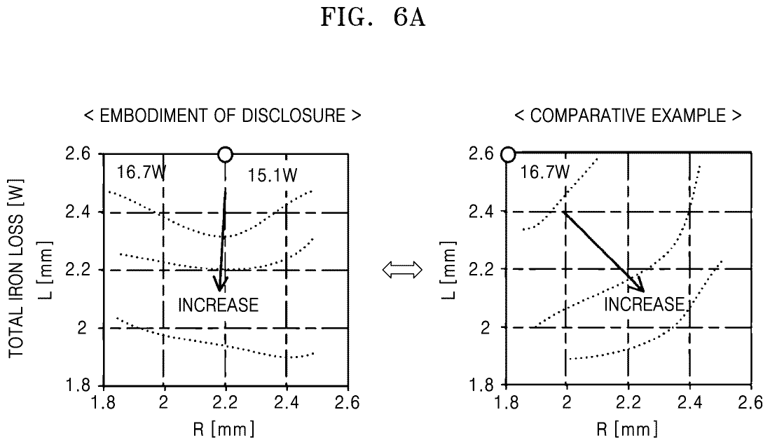

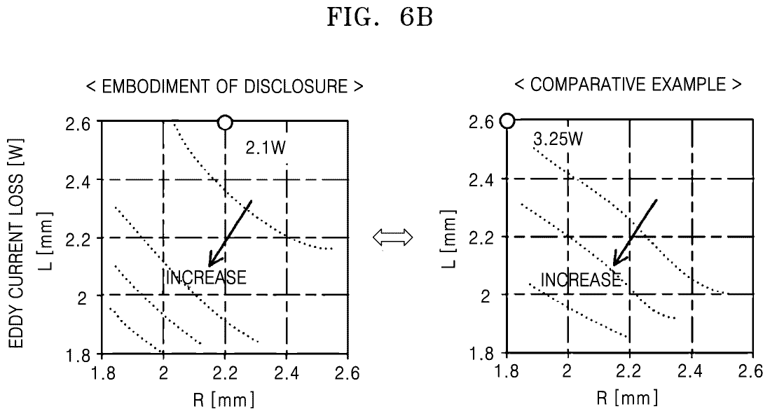

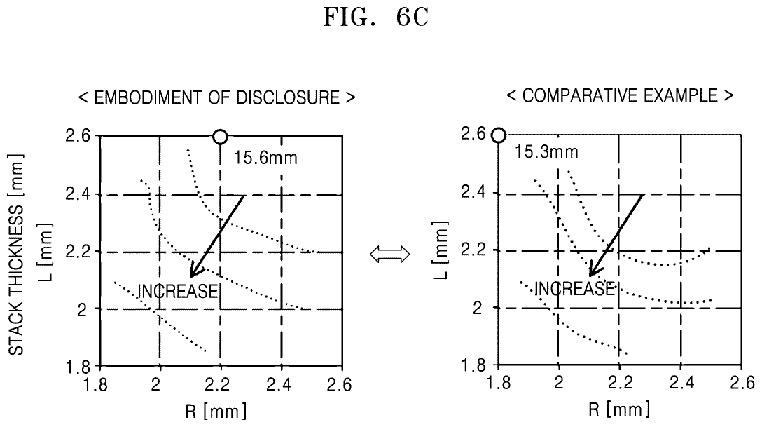

Referring to FIG. 5A, according to an embodiment of the disclosure, the motor model in which the fan motor 13 described above is simplified, is used. That is, a slot combination, the shape of teeth, etc., of the motor model are the same as those of the fan motor 13 described above. According to a comparative example shown in FIG. 5B, a motor model in which two flange portions of teeth are symmetrical (a shape of the first flange portion 71 is used for both of the flange portions) is used, according to the related art. L indicates a protrusion amount W1, and R indicates a protrusion amount W2. FIGS. 6A, 6B, and 6C are graphs showing simulation results. FIG. 6A shows a simulation result with respect to a relationship between protrusion amounts of first and second flange portions and the total iron loss. FIG. 6B shows a simulation result with respect to a relationship between the protrusions amounts of first and second flange portions and the eddy current loss. FIG. 6C shows a simulation result with respect to a relationship between the protrusion amounts of the first and second flange portions and the stack thickness. The graphs of FIGS. 6A, 6B, and 6C show the simulation results when the air gap Ga is 0.5 mm. In the graphs of FIGS. 6A, 6B, and 6C, L of a vertical axis indicates the protrusion amount W1, and R of a horizontal axis indicates the protrusion amount W2. In the graphs of FIGS. 6A, 6B, and 6C, arrows indicate directions in which the total iron loss, the eddy current loss, and the stack thickness increase, and broken lines indicate isopleths of the total iron loss, the eddy current loss, and the stack thickness. The total iron loss may be relatively greater and may have greater effects than the eddy current loss.

Referring to FIG. 6A, according to the comparative example, as L increases and R decreases, the total iron loss may decrease, and as L decreases and R increases, the total iron loss may increase. However, according to an embodiment of the disclosure, as L increases, the total iron loss may decrease, and as L decreases, the total iron loss may increase. However, the total iron loss may not be greatly affected by an increase or decrease of R. Thus, according to an embodiment of the disclosure, the size of R may be selected, while minimizing the total iron loss However, according to the comparative example, a condition for minimizing the total iron loss is limited to a certain condition (L=2.6 mm, R=1.8 mm). Also, while a smallest value of the total iron loss is 16.7 W according to the comparative example, the same is 15.1 W according to the embodiment of the disclosure. Thus, it is identified that the total iron loss may be reduced by about 10% according to the embodiment of the disclosure.

Referring to FIGS. 6B and 6C, it is identified that the effects of the sizes of L and R on the eddy current loss and the stack thickness are not greatly different between the embodiment of the disclosure and the comparative example. However, according to an embodiment of the disclosure, the size of R may be selected. Thus, an optimal value of R may be selected by taking into account the effects on both of the eddy current loss and the stack thickness.

In detail, as described above, the distance W1 between the central line CL of the teeth 62 and the protruding end portion 71a of the first opposite surface 75 may be greater than the distance W2 between the central line CL of the teeth 62 and the protruding end portion 72b of the second opposite surface 76. In the case of the fan motor 13 according to an embodiment of the disclosure, for example, L=2.6 mm and R=2.2 mm may be selected as the optimal condition.

However, according to the comparative example, the eddy current loss is 3.25 W even at a condition (L=2.6 and R=1.8) for the least total iron loss and may be greater than 2.1 W at an optimal condition according to the embodiment of the disclosure. Likewise, while the stack thickness at the condition (L=2.6 and R=1.8) for the least total iron loss is 15.3 mm according to the comparative example, the stack thickness is 15.6 mm at the optimal condition according to the embodiment of the disclosure and is almost the same as the stack thickness of the comparative embodiment of the disclosure.

Thus, according to an embodiment of the disclosure, a pair of asymmetrical flange portions may be implemented, and thus, the total iron loss and the eddy current loss may be reduced, while not causing an increase in weight, compared to a case according to the comparative example, where a pair of symmetrical flange portions are implemented.

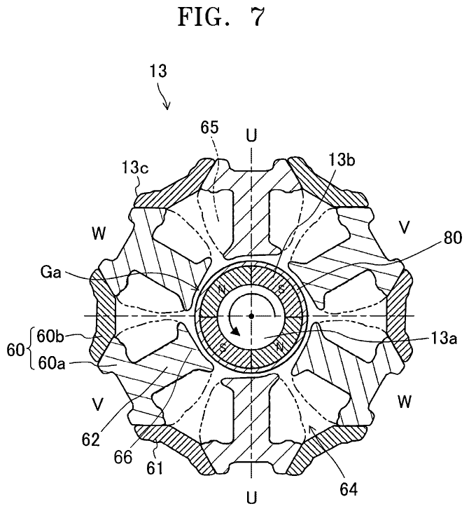

The suction fan 10 according to an embodiment of the disclosure is not limited to the suction fan 10 according to the embodiment of the disclosure described above. FIG. 7 is a schematic lateral cross-sectional view of the fan motor 13 according to an embodiment of the disclosure.

For example, according to a previous embodiment of the disclosure, the fan motor 13 in which the permanent magnet 50 is arranged at an outer surface of the rotor 13b is illustrated. When the rotor 13b rotates at a high speed, the permanent magnet 50 may be dropped and scattered. To prevent the scattering of the permanent magnet 50, a metal cover 80 having a cylindrical shape may be wrapped around an outer circumferential surface of the rotor 13b, as illustrated in FIG. 7.

In the case of the fan motor 13 according to an embodiment of the disclosure illustrated in FIG. 7, heat generation may occur in the metal cover 80 due to eddy currents. The eddy current loss may likewise occur even when the permanent magnet 50 having high resistivity, such as a ferrite magnet, a bond magnet, etc., is implemented as a magnet pole of the rotor 13b. Thus, the structure in which the outer circumferential surface of the rotor 13b is covered by the metal cover 80 may still be applied to the fan motor 13 according to the present disclosure.

A cleaner according to an aspect of the disclosure may include: a suction fan including a fan motor and an impeller, the impeller being configured to be rotated by the fan motor to generate a suction force necessary to suck in impurities on a surface to be cleaned; and a dust collection bin in which the impurities sucked in from the surface to be cleaned are accommodated. The fan motor may include: a shaft rotatable with respect to a rotational axis; a rotor including a plurality of magnetic poles arranged in a rotation direction, the rotor being fixed to the shaft; and a stator including a core ring having an annular shape, a plurality of teeth protruding from the core ring toward the rotational axis and arranged radially, and a plurality of coils arranged in the plurality of teeth, respectively. Each of the plurality of teeth may include a protruding end facing the rotor with an air gap therebetween, a first flange portion, which protrudes in the rotation direction from the protruding end, and a second flange portion, which protrudes in an opposite direction of the rotation direction from the protruding end. The first flange portion and the second flange portion may be asymmetrical with respect to a central line of the teeth extending from the rotational axis.

Based on this configuration, the distance between the first flange portion of a tooth and the second flange portion of a tooth adjacent to the tooth may increase, compared to a structure in which the first flange portion is symmetrical with the second flange portion with respect to the central line. As a result, leakage flux may be reduced, and thus, the performance of the fan motor may be improved.

According to an embodiment of the disclosure, the second flange portion may include a second opposite surface, which faces the air gap and extends from the central line in the opposite direction of the rotation direction. A second gap, which is a distance between the second opposite surface and an outer circumferential surface of the rotor, may increase in the opposite direction of the rotation direction.

The second gap may gradually increase away from the central line of the teeth, and thus, the magnetic flux may gradually decrease at the opposite directional side of the teeth. Thus, generation of eddy currents may be reduced in the rotor, and thus, heating of the rotor may be effectively suppressed. As a result, a rare earth sintered magnet having little resistivity may be implemented in the rotor, and thus, the magnetic force of the magnetic poles of the rotor may be strengthened.

According to an embodiment of the disclosure, the first flange portion may include a first opposite surface, which faces the air gap and extends from the central line in the rotation direction. A first gap, which is a distance between the first opposite surface and the outer circumferential surface of the rotor, may be constant.

Torques of a motor may decrease as the second gap increases. However, when the first gap is constant, deterioration of the torques may be suppressed at the rotation directional side of the teeth. Thus, while suppressing the deterioration of the torques, the eddy currents may be reduced, and thus, the performance of the fan motor may be improved in a balanced way.

According to an embodiment of the disclosure, the first opposite surface may have an arc shape that is concentric with the outer circumferential surface of the rotor, and the second opposite surface may be a plane perpendicular to the central line.

According to an embodiment of the disclosure, a distance between the central line and a protruding end portion of the second opposite surface may be greater than a distance between the central line and a protruding end portion of the first opposite surface.

Based on this configuration, as described with reference to FIGS. 6A, 6B, and 6C, while maintaining the stack thickness of a stator core, it is possible to reduce the iron loss and the eddy current loss in a balanced way, and thus, the fan motor may be lightweight and at the same, may have improved efficiency.

According to an embodiment of the disclosure, each of the plurality of teeth may include a pair of side surfaces, each of which is located at a same distance from the central line. The first flange portion and the second flange portion may protrude from the pair of the side surfaces, respectively. Protrusion amounts of the first flange portion and the second flange portion from the pair of the side surfaces may increase toward the rotational axis.

According to an embodiment of the disclosure, a distance from the rotational axis to a first inflection point, which is a boundary portion between the first flange portion and the side surface, may be equal to a distance from the rotational axis to a second inflection point, which is a boundary portion between the second flange portion and the side surface.

Based on this configuration, lengths of the pair of the side surfaces, from which the first flange portion and the second flange portion protrude, respectively, may be the same. Thus, even when the shapes of the first flange portion and the second flange portion are asymmetrical, bad effects caused by the flange portions, such as deterioration of a space factor of the coil winded around the teeth, collapse of the winding, etc., may be prevented.

According to an embodiment of the disclosure, the plurality of coils may form a three-phase coil group.

According to an embodiment of the disclosure, the rotor may include a permanent magnet including the plurality of magnetic poles and having a resistivity that is 10 Ω·cm or less.

For the magnetic poles of the rotor, a rare earth sintered magnet having a high magnetic force may be desirable, but the rare earth sintered magnet may have a resistivity that is 10 Ω·cm or less, and thus, it may be very easy for electricity to flow therethrough. Thus, when the permanent magnet as described above is used to form the magnetic pole, eddy currents may easily occur. However, according to the fan motor according to the disclosure, the occurrence of eddy currents may be suppressed according to the structure in which the shapes of the first flange portion and the second flange portion are asymmetrical with each other, and thus, the rare earth sintered magnet may be implemented in the magnetic poles of the rotor. Thus, the performance of the fan motor may be improved.

According to an embodiment of the disclosure, the fan motor may further include a metal cover covering the outer circumferential surface of the rotor.

When the rotor rotates at a high speed, the permanent magnet may be dropped and scattered. However, by implementing the metal cover, the scattering of the permanent magnet may be prevented.

A fan motor according to an aspect of the disclosure may include: a shaft rotatable with respect to a rotational axis; a rotor including a plurality of magnetic poles arranged in a rotation direction, the rotor being fixed to the shaft; and a stator including a core ring having an annular shape, a plurality of teeth protruding from the core ring toward the rotational axis and arranged radially, and a plurality of coils arranged in the plurality of teeth, respectively. Each of the plurality of teeth may include a protruding end facing the rotor with an air gap therebetween, a first flange portion, which protrudes in the rotation direction from the protruding end, and a second flange portion, which protrudes in an opposite direction of the rotation direction from the protruding end. The first flange portion and the second flange portion may be asymmetrical with respect to a central line of the teeth extending from the rotational axis.

According to an embodiment of the disclosure, the first flange portion may include a first opposite surface, which faces the air gap and extends from the central line in the rotation direction. The second flange portion may include a second opposite surface, which faces the air gap and extends from the central line in the opposite direction of the rotation direction. A first gap, which is a distance between the first opposite surface and an outer circumferential surface of the rotor, may be constant. A second gap, which is a distance between the second opposite surface and the outer circumferential surface of the rotor, may increase in the opposite direction of the rotation direction.

According to an embodiment of the disclosure, a distance between the central line and a protruding end portion of the second opposite surface may be greater than a distance between the central line and a protruding end portion of the first opposite surface.

According to an embodiment of the disclosure, the rotor may include a permanent magnet including the plurality of magnetic poles and having a resistivity that is 10 Ω·cm or less.

According to an embodiment of the disclosure, the fan motor may further include a metal cover covering the outer circumferential surface of the rotor.

The technical effects to be achieved by the disclosure are not limited to the technical effects described above, and other technical effects that are not described above may be clearly understood by one of ordinary skill in the art from the description herein.

As described above, the cleaner and the fan motor according to the disclosure is described according to limited embodiments of the disclosure and drawings. However, the disclosure is not limited to the embodiments of the disclosure described above and may allow various modifications within the range not deviating from the purpose of the disclosure.

1. A cleaner comprising:
a suction fan including:
a fan motor, and
an impeller configured to be rotated by the fan motor to generate a suction force to suck in impurities on a surface to be cleaned; and
a dust collection bin to accommodate sucked in impurities,
wherein the fan motor includes:
a shaft that is rotatable about a rotational axis of the shaft,
a rotor fixed to the shaft, and including a plurality of magnetic poles arranged in a rotation direction of the rotor, and
a stator including:
a core ring having an annular shape,
a plurality of teeth protruding from the core ring toward the rotational axis and arranged radially, and
a plurality of coils arranged so that each coil of the plurality of coils is respectively wound around one tooth of the plurality of teeth,
wherein each tooth of the plurality of teeth includes:
a protruding end facing the rotor with an air gap between the protruding end and an outer circumferential surface of the rotor,
a first flange portion protruding from the protruding end in the rotation direction of the rotor, and
a second flange portion protruding from the protruding end in an opposite direction of the rotation direction of the rotor,
wherein the first flange portion and the second flange portion are asymmetrical with respect to a central line of the tooth extending from the rotational axis.

2. The cleaner of claim 1, wherein
the second flange portion includes a second opposite surface which faces the air gap and extends from the central line in the opposite direction of the rotation direction of the rotor, and
a distance of the air gap between the second opposite surface and an outer circumferential surface of the rotor increases in the opposite direction of the rotation direction of the rotor.

3. The cleaner of claim 2, wherein
the first flange portion includes a first opposite surface which faces the air gap and extends from the central line in the rotation direction of the rotor, and
a distance of the air gap between the first opposite surface and the outer circumferential surface of the rotor is constant.

4. The cleaner of claim 3, wherein
the first opposite surface has an arc shape that is concentric with the outer circumferential surface of the rotor, and
the second opposite surface is a plane perpendicular to the central line.

5. The cleaner of claim 3, wherein
a distance between the central line and an end of the second flange portion is greater than a distance between the central line and an end of the first flange portion.

6. The cleaner of claim 1, wherein
each tooth of the plurality of teeth includes a first side surface and a second side surface opposite to the first side surface, each of the first side surface and the second side surface being located a same distance from the central line,
the first flange portion protrudes from the first side surface,
the second flange portion protrudes from the second side surface.

7. The cleaner of claim 6, wherein
a distance from the rotational axis to a first inflection point, the first inflection point being a boundary between the first flange portion and the first side surface, is equal to a distance from the rotational axis to a second inflection point, the second inflection point being a boundary between the second flange portion and the second side surface.

8. The cleaner of claim 1, wherein
the plurality of coils form a three-phase coil group.

9. The cleaner of claim 1, wherein
the rotor includes a permanent magnet including the plurality of magnetic poles and having a resistivity that is 10 Ω·cm or less.

10. The cleaner of claim 1, wherein
the fan motor includes a metal cover covering an outer circumferential surface of the rotor.

11. A fan motor comprising:
a shaft that is rotatable about a rotational axis of the shaft;
a rotor fixed to the shaft, and including a plurality of magnetic poles arranged in a rotation direction of the rotor; and
a stator including:
a core ring having an annular shape,
a plurality of teeth protruding from the core ring toward the rotational axis and arranged radially, and
a plurality of coils arranged so that each coil of the plurality of coils is respectively wound around one tooth of the plurality of teeth,
wherein each tooth of the plurality of teeth includes:
a protruding end facing the rotor with an air gap between the protruding end and an outer circumferential surface of the rotor,
a first flange portion protruding from the protruding end in the rotation direction of the rotor, and
a second flange portion protruding from the protruding end in an opposite direction of the rotation direction of the rotor,
wherein the first flange portion and the second flange portion are asymmetrical with respect to a central line of the tooth extending from the rotational axis.

12. The fan motor of claim 11, wherein
the first flange portion includes a first opposite surface which faces the air gap and extends from the central line in the rotation direction of the rotor,
the second flange portion includes a second opposite surface which faces the air gap and extends from the central line in the opposite direction of the rotation direction of the rotor,
a distance of the air gap between the first opposite surface and an outer circumferential surface of the rotor is constant, and
a distance of the air gap between the second opposite surface and the outer circumferential surface of the rotor increases in the opposite direction of the rotation direction of the rotor.

13. The fan motor of claim 12, wherein
a distance between the central line and an end of the second flange portion is greater than a distance between the central line and an end of the first flange portion.

14. The fan motor of claim 11, wherein
the rotor includes a permanent magnet including the plurality of magnetic poles and having a resistivity that is 10 Ω·cm or less.

15. The fan motor of claim 11, further comprising:
a metal cover covering an outer circumferential surface of the rotor.
